(19) United States
(12) Patent Application Publication
(10) Pub. No.: US 2012/0229596 A1
(43) Pub. Date: Sep. 13, 2012

(54) Panoramic Imaging and Display System With Intelligent Driver's Viewer

(76) Inventors: Michael Kenneth Rose, Chicopee, MA (US); Kevin Robert Andryc, Ludlow, MA (US); Jesse David Chamberlain, Huntington, MA (US); Daniel Lawrence Lavalley, Southampton, MA (US)

(21) Appl. No.: 13/339,035

(22) Filed: Dec. 28, 2011

Related U.S. Application Data
(63) Continuation-in-part of application No. 12/049,068, filed on Mar. 14, 2008, now Pat. No. 8,106,936.
(60) Provisional application No. 60/918,489, filed on Mar. 16, 2007.

(51) Int. Cl. H04N 5/225

(52) U.S. Cl. 348/36; 348/E05.024

(57) ABSTRACT

A system for low-latency, high-resolution, continuous motion, staring panoramic video imaging includes a plurality of high-resolution video cameras, each video camera generating about at least 500 kilopixel near-real time video. The cameras can be supported for positioning the plurality of cameras at predetermined angular locations to generate a full 360 degree field of view. The system can also include an image processor for processing video image signals in parallel and providing panoramic images. In one embodiment, the system can include a display to provide seamless panoramic images. In another embodiment, the panoramic imaging and display system incorporates an intelligent driver's viewer for use with vehicles which can intelligently and adaptively select and display a separate field of view in response to a variety of internal and external data inputs.

### CROSS-REFERENCE TO RELATED APPLICATIONS

This application is a continuation-in-part of pending U.S. patent application Ser. No. 12/049,068, filed on Mar. 14, 2008, which claims the benefit of U.S. Provisional Patent Application Ser. No. 60/918,489, filed on Mar. 16, 2007, both of which are herein incorporated by reference in their entirety.

### FIELD OF THE INVENTION

The present inventions relate to image data processing and more particularly to a system for the processing and display of imagery that combines panoramic viewing with an intelligent, adaptive display of real time images permitting simultaneous visual situational awareness and remote piloting and navigation under various and changing vehicle conditions.

### BACKGROUND

The majority of the U.S. Navy's submarines still depend on the use of the age old periscope. At periscope depth, both the periscope and even the latest generation of non-penetrating photonics masts, which are installed on Virginia Class submarines for example, are still required to be rotated to view specific contacts. When operating passively in a contact dense environment, such manual contact identification can be time consuming and, in some instances, put the submarine in potentially hazardous situations.

Current panoramic systems primarily use one of two approaches. The first approach uses a specialized optic that images 360 degrees on the horizon onto a circle of the imaging focal plane. Image processing is used to map the circle into a straight line for display. However, this approach suffers from several shortcomings. Namely, the highest achievable resolution of the system is limited by the size of the focal plane/planes that can be physically utilized in the optical arrangement. In addition, optical resolution is not uniform over the field of view. Typically this is many fewer pixels than can be implemented using a number of separate cameras. This approach also suffers from mechanical challenges due to the need for a continuous transparent cylinder that must also provide a measure of structural rigidity.

The second approach uses several more standard video cameras arrayed on a circumference to image the complete circle. Typically, image processing software running on a general purpose processor would be used to reassemble or stitch the separate images into a single continuum, or alternatively several long image segments. This approach is computationally intensive, inefficient, cumbersome and may result in significant latency and processing overhead. Thus, there is a need in the art for an improved high resolution real time panoramic imaging system.

In addition, imaging systems currently in use on a variety of vehicles, including on military vehicles and in some automotive applications, employ generally fixed field of view, stationary cameras pointing directly ahead of the vehicle. In the case of military vehicles, these Driver Vision Enhancement (DVE) devices permit a driver to remotely steer or navigate even without the benefit of direct visual contact with the exterior environment. Similarly, some automobiles employ a thermal imaging camera pointed directly ahead of the vehicle providing the driver with additional visual cues at night or when visibility is reduced. The cameras used in these applications are typically a fixed field of view of approximately 40 degrees and are directed directly ahead of the vehicle. Some military camera systems mount the camera on a mechanical pan and tilt device that is under the manual control of an operator or driver. While this allows the camera line of sight to be redirected left or right so that more scene information may be gathered, it also poses the serious risk of distracting the driver from his main mission of piloting the vehicle.

In any case, standard DVE devices limit the total view and the amount of information available to the driver at any instant of time and may deprive him of valuable cues required to safely pilot his vehicle. Moreover, it is a consistent and stated requirement that military vehicles, being vulnerable to threats from many directions, should be capable of displaying fully panoramic imagery that provides situational awareness to the crew even as the driver is piloting the vehicle using his own dedicated remote display. Finally, other cameras facing toward the rear or side on both military and commercial vehicles are often installed that provide additional safety and security. Therefore, there is a need for a system that combines the unique demands of panoramic imaging for full situational awareness with the necessity to optimize vehicle piloting and navigation capabilities.

### BRIEF SUMMARY OF THE INVENTION

Disclosed and claimed herein are systems for low-latency, high-resolution, continuous motion, staring panoramic video imaging. Also disclosed and claimed herein are systems that combine the advantages of such panoramic video imaging with advanced capabilities for intelligent and adaptive piloting and navigation. These systems have potential application to all types of military, commercial, and industrial vehicles that take advantage of remote camera systems where the driver may be situated in the vehicle or may be a remote pilot. In particular, these systems are well-suited to applications on military armored vehicles, remotely piloted vehicles that are deployable on land, sea, or in the air, while exploiting the best qualities of available camera imaging technologies to enhance safety and maneuverability.

In one embodiment, the system includes a plurality of high-resolution video cameras generating near-real time video camera image signals. A support is provided for positioning the plurality of cameras at predetermined angular locations to generate video camera image signals encompassing a full 360 degree field of view. The system includes an image processor coupled to the plurality of cameras via a communication link and configured to receive the video camera image signals from the plurality of video cameras, process the video camera image signals together in parallel and generate a panoramic image signal. The image processor can be coupled to a display via a second communication link, the display capable of showing panoramic images in the field of view around the plurality of cameras in near-real time. The panoramic imaging system may be configured to cover the complete 360 degree circumference around a vehicle, or it may cover some lesser angle, depending on the particular application or specific needs. Accordingly, the panoramic imaging system delivers continuous high resolution, real time imagery of the full field of view being covered.

In another embodiment, the panoramic image is electronically shared with a separate display or displays, one of which may be used by the driver of the vehicle for a variety of purposes, including piloting and navigation. The imagery transmitted to the display used by the driver is herein termed the “driver's display window” and the process of sharing a portion of the 360 degree field of view does not affect the panoramic image in any way. The driver's display window provides selectable display options including any combination of a full panoramic image, and one or more segments or portions of the 360 degree panoramic image. The sizes and locations of these image segments are independent of one another and may be variable as described further herein. Intelligent and adaptive properties may be embedded into the selected driver's display window using various inputs gathered from vehicle systems. Image processing hardware in combination with software and firmware programming methods are employed to provide the features described herein. These features are available continuously and immediately and include, but are not limited to the following: (a) adaptive control of the size of the field of view of the driver's display window and its pointing direction, which may depend on any combination of vehicle speed, vehicle maneuvers and/or road conditions; (b) continuous control of the pointing direction of the center of the driver's display window such as is required when negotiating a turn or putting the vehicle into reverse gear; (c) intelligent modification of the field of view size and the central pointing direction of the driver's display window using any combination of global positioning system (GPS) data including GPS location and routing maps and/or other traffic information systems; (d) slewing of the line of sight of the driver's display window in response to external commands or commands from ancillary systems aboard the vehicle; (e) slewing of the line of sight in response to the physical state of the driver or a remote operator including body movements, head and/or eye motion, hand gestures or voice commands; (f) the appending and display of metadata onto the driver's display window including any combination of information such as vehicle speed and heading, fuel level, GPS maps, GPS routing and the status of external and ancillary systems; and (g) presenting more than one region or portion of the 360 degree panoramic view to the driver on the driver's display window, including a simultaneous view pointing frontward and rearward of the vehicle.

Other aspects, features, and techniques of the inventions will be apparent to one skilled in the relevant art in view of the following detailed description of the inventions.

### BRIEF DESCRIPTION OF THE DRAWINGS

The features, objects, and advantages of the inventions disclosed herein will become more apparent from the detailed description set forth below when taken in conjunction with the drawings in which like reference characters identify correspondingly throughout and wherein:

FIG. 1 is a block diagram of a 360 degree imaging system according to one or more embodiments of the invention;

FIG. 2 is a simplified block diagram of a 360 degree imaging system according to one or more embodiments of the invention;

FIG. 3 is a plan view of a sensor pod showing the layout of the imaging devices, according to one embodiment of the invention;

FIG. 4 is a block diagram depicting the logical flow of an image processing algorithm in accordance with one or more embodiments of the invention;

FIG. 5 is a block diagram depicting an image processing algorithm in accordance with one or more embodiments of the invention;

FIG. 6 is a block diagram of a 360 degree imaging system according to one or more embodiments of the invention which illustrates a driver's display window having a selectable display;

FIG. 7 is a diagram illustrating multiple fields of view that may be imaged and displayed according to one or more embodiments of the invention; and

FIG. 8 is a plan view of a partial panoramic display according to one or more embodiments of the invention which illustrates an example of adaptive sizing and location of a selected driver's display window.

### DETAILED DESCRIPTION OF EXEMPLARY EMBODIMENTS

### Overview of the Disclosure

One aspect of the present invention relates to a panoramic imaging device. In one embodiment, an imaging device may be provided to include a plurality of high-resolution video cameras. The plurality of high-resolution cameras may be mounted in a housing or pod configured to arrange the video cameras in a one of a secure and adjustable fashion. Further, the video cameras may be configured to provide still images, motion images, a series of images and/or any type of imaging data in general.

As will be described in more detail below, the plurality of high-resolution video cameras may generate at least 500 kilopixel, per camera, at a minimum of 24 frames per second, near-real time video camera image signals representative of images in the field of view of the respective cameras. It should also be appreciated that other pixel values may be used. For example, in one embodiment, each camera may be configured to provide 1 megapixel image signals. A support for positioning the plurality of cameras at predetermined angular locations may be used to enable the plurality of cameras to operate in unison to generate video camera image signals encompassing a full 360 degree field of view around the cameras.

Another aspect of the invention is to provide video camera image signals from the plurality of video cameras to an image processor. In one embodiment, the image processor may be configured to process the video camera image signals in parallel in order to generate seamless video signals representative of seamless panoramic images. Thereafter, the video signals may be provided to a display device, over a communication link, which may in turn display seamless panoramic images in the field of view around the plurality of cameras in near-real time. As used herein, seamless panoramic images may relate to a continuous 360 degree panoramic image with no breaks or distortion of the field of view. According to another embodiment, video signals may be displayed as a generally seamless image, such that image data is displayed in a near continuous fashion. In another embodiment, the 360 degree seamless panoramic image and/or one or more segments or portions of the 360 degree panoramic image may be selected to be shared with one or more additional display devices which may be used for a variety of purposes, including driving or navigation.

Features of the panoramic imaging system may be useful in the context of submarine applications. In certain embodiments, the invention may provide a 360-degree continuous image of the horizon at video rates. In certain embodiments, the invention may enable a submarine to observe all contacts instantaneously without rotation of either the periscope or the mast. It should also be appreciated that the panoramic imaging system may be usable for other applications such as terrestrial based imaging, aerial imaging and any type of imaging in general.

In certain embodiments, panoramic imaging may improve a submarine's situational awareness and collision avoidance capabilities. The captain and crew, as users of the system, are expected to be able to assess ship's safety and the external environment quickly with minimal operator intervention. To that end, display of a seamless panoramic field of view is desirable on a single, high-resolution video monitor. In another embodiment, the panoramic imaging may provide situational awareness as well as navigation capabilities for a military ground vehicle. The vehicle commander would have the ability to monitor the full vehicle surroundings through the primary display, while the vehicle driver would have a dedicated display providing portions of the surrounding video relevant to piloting the vehicle.

Based on the teachings of the invention, resolution enhancements may be possible by the addition of cameras and processing resources for both single-display implementations, as well as multiple-display implementations. In other embodiments, a virtual display using projection goggles or a similar system may also be used in which the image displayed may be based detecting the operator's orientation. Additional embodiments, aspects, features, and techniques of the invention will be further detailed below.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner on one or more embodiments without limitation.

When implemented in firmware, the elements of the invention are essentially the code segments to perform the necessary tasks. The program or code segments can be stored on any processor readable medium.

### Exemplary Embodiments of the Invention

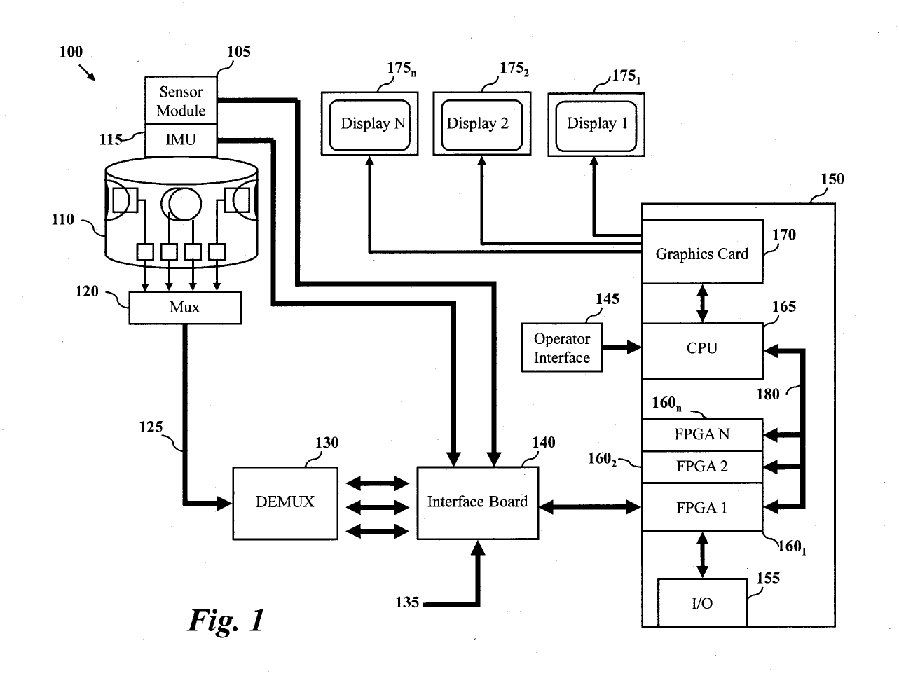

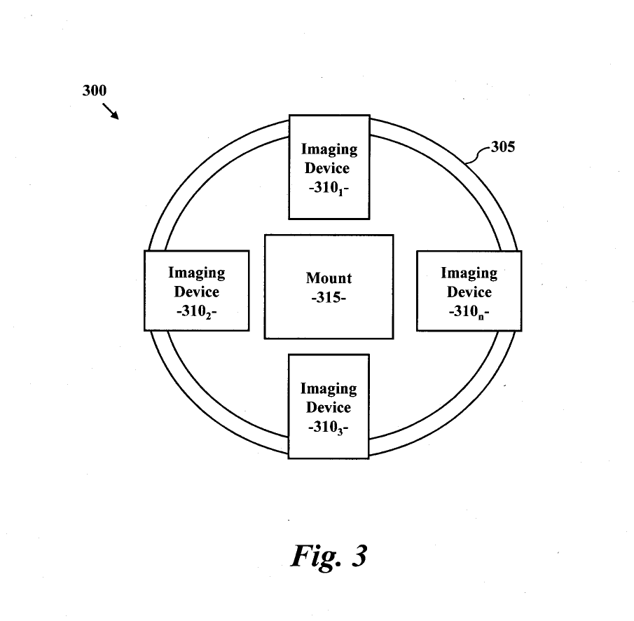

Referring now to the figures, FIG. 1 depicts a top level block diagram of an imaging system 100, which in one embodiment corresponds to a low-latency, high-resolution, continuous motion panoramic video imaging system. As depicted in FIG. 1, system 100 includes a sensor pod 110, further shown in plan view in FIG. 3 as sensor 300. In one embodiment, sensor pod 110 may include a pressure-resistant enclosure or housing. According to another embodiment, sensor pod 110 comprises a plurality of imaging outputs which may be multiplexed onto a fiber (or RF) channel 125 by multiplexer 120 and transmitted to image processor 150, which may be comprised of two or more suitable digital signal processors, such as application specific integrated circuitry (ASIC) or Field Programmable Gate Array (FPGA) circuitry or boards 160₁₋ₙ after being de-multiplexed by de-multiplexer 130. In certain embodiments, the sensor pod 110 may comprise a plurality of high-resolution video cameras. Such high-resolution video cameras may be configured to generate at least 500 kilopixels per frame, at a minimum of 24 frames per second, per camera, near-real time video camera image signals representative of images in the field of view of the respective camera. It should also be appreciated that the high-resolution cameras may generate high-resolution imaging data which may be characterized by other pixel values. For example, in one embodiment, high-resolution may relate to image signals data of at least 500 kilopixels. As used herein, near real-time may relate to no more than 60 to 100 msec of latency. However, it should be appreciated that other latency values may be used.

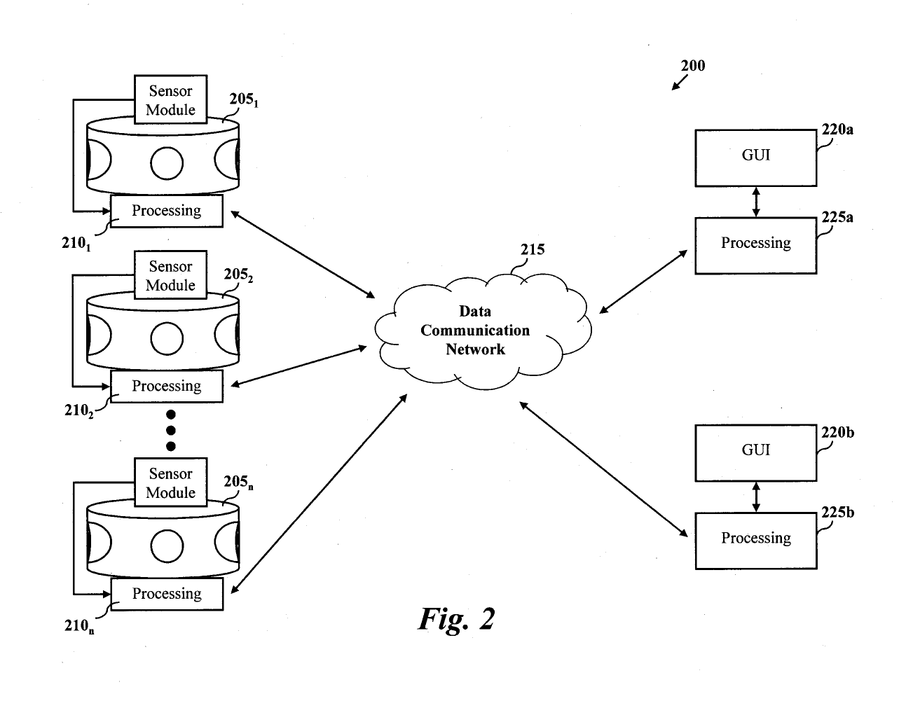

While the image processor 150 may be positioned proximate to the sensor pod 110, in another embodiment a system center may be used for communication with one or more video imaging systems (e.g., system 100). Similarly, the system center may be used for controlling operation of the one or more video imaging systems remotely as will be discussed in more detail with reference to FIG. 2.

Although not depicted in FIG. 1, it should be appreciated that the sensor pod 110 may be coupled to or integrated with a support for positioning the sensors (e.g., plurality of cameras) at predetermined angular locations so as to enable the plurality of cameras to together generate video camera image signals encompassing a full 360 degree field of view around the plurality of cameras.

In one embodiment, the FPGA board(s) 160₁₋ₙ may be integrated into a high-speed image processor 150, as shown in FIG. 1. Moreover, processor 150 may be electrically connected to a display, such as display 175₁, for displaying the resulting image data. Processor 150 may be connected to additional displays 175₁₋ₙ that can display either the same or distinct selected segments or portions of the overall panorama. By way of example, the image processor 150 processes the video camera image signals received from the sensor pod 110 together, in parallel, to generate video signals that are representative of the seamless panoramic images captured by the video cameras. According to another embodiment, image data received from sensor pod 110 may be processed serially. These signals may then be transmitted to a display, such as display 175₁, for near-real time display of seamless panoramic images in the field of view around the plurality of cameras. In one embodiment, CPU 165 may be configured to receive and handle imaging data to be supplied to graphics card 170. CPU 165 may further be configured to receive control information from operator interface 145. Such control information could consist of commands that designate a region of interest in the display or that designate a position of a secondary display window. In other embodiments, the imaging data collected by sensor pod 110 may relate to at least one of visual imaging data, non-visual imaging data, infrared data, thermal imaging data, microwave imaging data, magnetic imaging data, etc.

It may be appreciated that data collected by the sensors within sensor pod 110 may be collected from fiber channel 125 using demux 130, interface board 140 and/or input/output (I/O) card 155. According to another embodiment, I/O card 155 may be used to receive and/or output one or more signals including imaging and non-imaging data. In that fashion, I/O card 155 may be used to receive various types of other data signals not provided by sensor pod 110 including, but not limited to, radar data, platform data, etc. In yet another embodiment, I/O card 155 may be configured to receive commands from a remote location over any of a wired or wireless link. According to another embodiment, I/O card 155 may receive metadata related to one or more of global positioning system (GPS) data, time stamp data, heading, speed and operating coordinates which may be associated with sensor pod 110. Further, I/O card 155 may be used to output video such as compressed video over IP.

In addition, system 100 may further comprise motion compensation algorithms for stabilizing image data. The motion compensation algorithm may be configured to modify video signals to adjust for movement. In one embodiment, inertial measurement unit (IMU) 115 may be configured to provide one or more output signals characterizing motion of sensor pod 110 to interface board 140. To that end, output of IMU 115 may be used to modify video signals to adjust for movement.

In one embodiment, the motion compensation algorithm may utilize a generally fixed object in the field of vision of one of the video cameras to adjust the video camera image signals generated from additional video cameras. In essence, a video data subtraction process may be used to establish a baseline using the video signal resulting from a fixed object in the field of vision of at least one of the video cameras relative to the video camera image signals from the other video cameras. According to another embodiment, system 100 may include a circuit configured to perform video data subtraction.

By way of an example, IMU 115 may be in the form of a level sensor including, but not limited to one of a mechanical gyro and fiber optic gyro, which may be located within, or in proximity to, the sensor pod 110 and configured to sense the orientation and motion of sensor pod 110. In one embodiment, sensor pod 110 can sense the orientation and motion in inertial space and transmit corresponding data to a high-speed image processor 150. In certain embodiments, the image processor 150 (and/or the FPGA(s) 160₁₋ₙ thereon) may process the incoming video and perform one or more of the following:
Stabilization of images to correct orientation and compensate for platform motion,
Translation and registering of images to produce a continuous (stitched) display, and
Correction of image position in the azimuth plane to compensate for rotation about the azimuth axis so as to display images in true bearing coordinates.

Continuing to refer to FIG. 1, system 100 may include graphics card 170 for formatting output of image processor 150. In that fashion, imaging data may be provided to a single display, such as display 175₁, or a plurality of displays 175₁₋ₙ.

In one embodiment, the support may be carried on a mobile platform (e.g., submarine, naval surface vessel, tank, combat vehicle, etc.) subject to movement and the motion compensation algorithm may be used to modify the video signals to adjust for such movement.

According to another embodiment, the sensor pod 110 may include one or more non-visual sensors. For example, in one embodiment sensor 105 may be provided to gather non-visual data in the field of vision of the sensor pod 110, which may then be integrated with the output of the sensor pod 110. This output may then used to communicate the non-visual data to the image processor 150, wherein the image processor 150 may associate the non-visual data with the image data (e.g., seamless panoramic images) generated from the video camera image signals gathered at the same time as the non-visual data. Non-visual data detected by sensor 105 may be provided to image processor 150 via interface board 140.

In another embodiment, the sensor pod 110 may further include a global positioning sensor providing global positioning data to the image processor 150. Image processor 150 may then associate the global positioning data with the image data (e.g., seamless panoramic images) generated from the video camera image signals gathered at the same time as the non-visual data and/or metadata. By way of non-limiting examples, such non-visual data may relate to a true north indicator, bearing, heading, latitude, longitude, time of day, map coordinates, chart coordinates and/or platform operating parameters such as speed, depth and inclination.

In another embodiment, the cameras and optics of the system (e.g., sensor pod 110) may be designed to meet either Grade A (mission critical) or Grade B (non-mission critical) shock loads. In addition, thermal analysis may be used to dictate the cooling means required. Passive cooling methods may be used to conduct heat to the mast and ultimately to water when applied in marine applications. Active cooling methods may be less desirable for some applications. While sensor pod 110 has been described as including cameras and or optical components, it should equally be appreciated that electronically imaging devices may equally be used including electronic imaging devices and imaging devices in general.

Continuing to refer to FIG. 1, FPGA(s) 160₁₋ₙ may be integrated on other circuit cards. In one embodiment, FPGA(s) 160₁₋ₙ may relate to Xilinx Virtex 4 or 5, and may be integrated onto a circuit card by Nallatech, Inc. It may also be appreciated that the video interface circuit or board 150 may be configured to accept a multitude of digital video interface options, including but certainly not limited to SDI, GigE, Camera Link and digital video in general. In one embodiment, the custom interface board 140 may be used to interface high-speed, high-bandwidth digital video data directly with the FPGA(s) 160₁₋ₙ while not burdening bus 180 (e.g., PCI/PCIX bus). In that fashion, users of the system 100 and the associated imaging method, can assess the vicinity of a ship or location in a quick manner. Near real-time imaging by FPGA(s) 160₁₋ₙ may be provided by processing image signals generated by sensor pod 110 in parallel and/or in pipelined, or series, fashion. As used herein, processing in a pipelined processing may relate to processing imaging data based at least in part on order it is received. It would be advantageous to provide a 360 degree image in such a manner where time is of the essence. Further, parallel processing by FPGA(s) 160₁₋ₙ may facilitate motion compensation and/or stabilization of panoramic images. When sensor pod 110 is mounted to a platform subject to movement, motion compensation circuitry can modify video signals to adjust for such movement.

Although not depicted in FIG. 1, it should be appreciated that the system may further comprise automated detection algorithms for detecting movement of an object in the field of vision of at least one of the plurality of cameras. In one embodiment, an operator controlled device may be used for identifying an area of interest in the seamless panoramic images and controlling the image processor to provide additional image signal information to display a magnified view of the area of interest. Operator interface 145 may be configured to output one or more signals for control of the information displayed. In one embodiment, operator interface 145 may include an input device such as a mouse or touchscreen display. System 100 may also detect movement by comparing reference image frames to subsequent frames. Changes apparent in subsequent images may be used to indicate possible motion.

Referring now to FIG. 2, a simplified block diagram is shown of a imaging system according to one or more embodiments of the invention. As shown in FIG. 2, one or more sensor pods 205₁₋ₙ (e.g., sensor pod 110) may be configured to communicate with one or more processors 225a-225b via data communication network 215. According to one embodiment, each of the sensor pods 205₁₋ₙ may be configured to be controlled by a single workstation from a remote location. Each workstation can include a graphical user interface (GUI) 220a and processing logic 225a (e.g., image processor 150). In that fashion, imaging data, and/or non-imaging data, sensed by sensor pods 205₁₋ₙ may be processed remotely and presented to a user. According to another embodiment, each sensor pod 205₁₋ₙ may include processing logic 210₁₋ₙ to process imaging data prior to transmitting the imaging data over data communication network 215. Data 215 communication network may be one of a wired and wireless communication network.

Referring now to FIG. 3, a plan view of a sensor housing (e.g., sensor pod 110) is shown according to another embodiment of the invention. In particular, sensor pod 300 is shown including enclosure material 305, a plurality of imaging devices 310₁₋ₙ, and a mount/support 315. While in one embodiment, the imaging devices 310₁₋ₙ may be comprised of a plurality of high-resolution video cameras capable of generating at least 500 kilopixels per frame at a minimum of 24 frames per second, near-real time video camera image signals, it should equally be appreciated that numerous other type of imaging devices may be equally used consistently with the principles of the invention. For example, imaging devices may related to at least one of infrared (IR), short wave infrared (SWIR), electron multiplied charge coupled display (EMCCD), etc.

In certain embodiments, the camera enclosure material 305 may be a stainless steel cylinder. In addition, the wall thickness of the cylinder may be approximately ½ inch to survive deep submergence, although other appropriate material thicknesses may similarly be used. Further, it may be appreciated that the enclosure material 305 may be comprised of other types of material including, alloys, other metals, seamless, high strength materials in general, etc. The optical apertures for imaging devices 310₁₋ₙ may be constructed of quartz or sapphire, and may be sealed into the enclosure using redundant O-ring seals, for example. As shown in FIG. 3, optical paths of imaging devices 310₁₋ₙ may pass through enclosure material 305, and may be sealed and protected from an external environment. However, it may also be appreciated that imaging devices 310₁₋ₙ may be coupled to a support in a movable fashion.

Power and signals may pass through the enclosure (e.g., enclosure material 305) using pressure-proof, hermetic connectors, such as those manufactured by SEACON® Phoenix, Inc. with offices in Westerly, R.I. In certain embodiments, the sensor pod 300 may be mounted to a mast (such as a submarine periscope) with a threaded coupling. The outside diameter of the mast or periscope may include threads, as may the outside diameter of the sensor enclosure. The coupling ring has threads on its inside diameter. In one embodiment, the mount 315 may serve as a support for positioning the imaging devices 310₁₋ₙ at predetermined angular locations so as to enable the imaging devices 310₁₋ₙ to together generate video camera image signals encompassing a full 360 degree field of view around the sensor pod 300.

While FIG. 3 has been described as providing a enclosure for imaging devices 310₁₋ₙ, it should also be appreciated that each of the imaging devices may be mounted separately. For example, in one embodiment imaging devices 310₁₋ₙ may be mounted at or around the four quadrants of a vehicle. In that fashion, each of the imaging devices 310₁₋ₙ may be housed in a separate enclosure. Similarly, while FIG. 3 has been described related to submarine applications, it should be appreciated that sensor pod 300 may be mounted to one of a surface vessel, combat vehicle and any vehicle in general. When employed on ground vehicles, imaging devices 310₁₋ₙ may be mounted either as an integral assembly, which may include ballistic protection, to a high point on the vehicle. Alternatively, when employed on surface ships, imaging devices 310₁₋ₙ may be mounted either the a high point on the superstructure, fixed to a mast and/or deployable structure.

By way of example, the following two operational scenarios are provided to show how the invention may be adapted for varying operational conditions, according to one or more embodiments of the invention.

### Exemplary Operational Scenarios

Scenario 1 (Recognition of a Tanker at 5 Miles):

A tanker can be 300 meters in length. 5 mi is 8 km and the target subtense is 37.5 mRadians. Recognition requires at least 4 cycles or 8 pixels across the target dimension. Therefore, the pixel IFOV must be less than 4.7 mRad. A 1 mRad IFOV will easily satisfy this requirement.

Scenario 2 (Recognition of a Fishing Boat at 1 Mile):

A fishing boat is 10 meters in length. 1 mile is 1.6 km and the target subtense is 6.25 mRadians. Recognition requires at least 4 cycles or 8 pixels across the target dimension. Therefore, the pixel IFOV must be less than 0.78 mRad which is approximately 1 mRad. Therefore, a 1 mRad system should approximately satisfy this requirement.

A 1 mRad IFOV yields 6282 mRad around a 360 degree horizon. If allocated to 4 cameras, this gives approximately 1570 pixels required for each camera (e.g., imaging device 210₁₋ₙ of sensor 200). Cameras having 1600 pixels in the horizontal format are available. Assuming 3 to 5 degrees of horizontal overlap will provide good image registration, the following values may be used:
Camera horizontal field of view: 95 degrees
Horizontal pixel count: 1600 minimum
IFOV: 1.036 mRad
Camera vertical field of view 71.2 degrees

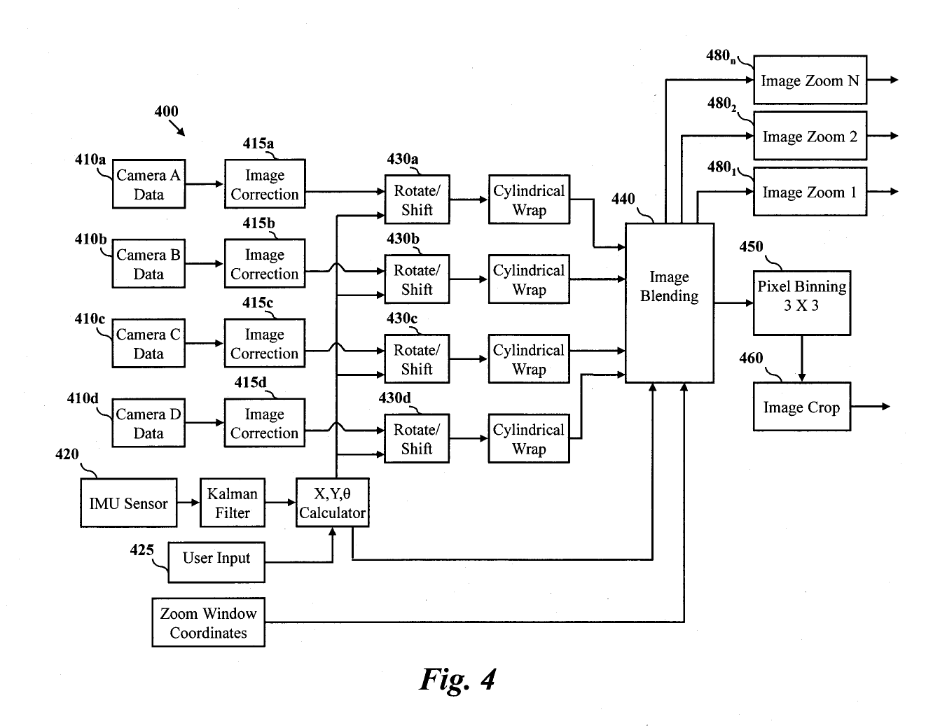

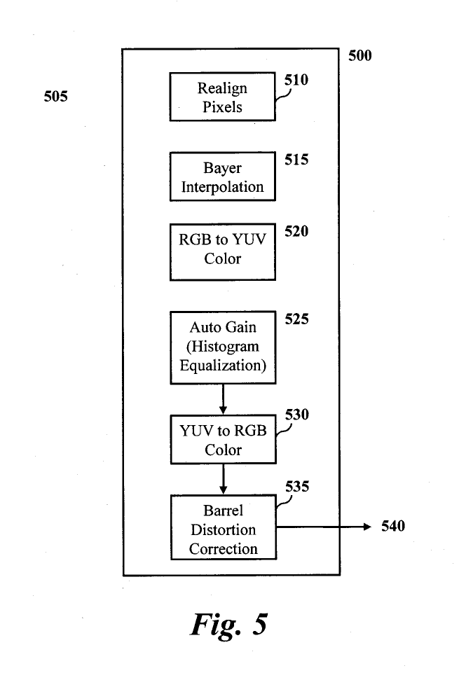

With reference now to FIG. 4, depicted is block diagram of an image processing sequence 400 performed by FPGA(s) (e.g., FPGA(S) 160₁₋ₙ of an image processor (e.g., image processor 150), according to one embodiment of the invention. As shown in FIG. 4, image data from the four cameras 410a-410d may first be rotated to correct for the tilt of the sensor (e.g., sensor pod 110) in two dimensions using inputs from IMU sensor 420 (e.g., IMU sensor 115). It should be appreciated that the four cameras 410a-410d may be integrated into a pressure-proof sensor that is configured in accordance with the principles of the invention (e.g., sensor pod 110 and/or sensor pod 200). According to another embodiment, imaging data provided by cameras 410a-410d may be corrected in blocks 415a-415c as will be described below in more detail with respect to FIG. 5.

Once adjusted for tilt, the received data may be translated at blocks 430a-430b using the known relative positions of the 4 cameras. Next, the image data may be blended at block 440 so as to create an essentially continuous panorama. After blending, pixels may be combined in the binner 450 since many displays may not have sufficient resolution to display full resolution. User input received at block 420 may indicate desired views including enlarging and/or manipulation of received image data. Thereafter, image cropping at block 460 may be performed to a chosen vertical size before splitting image date into two or more sections such that data may be displayed.

Continuing to refer to FIG. 4, many displays will have fewer pixels than will be imaged by the imaging system of the invention (e.g., system 100). Therefore, pixels may need to be combined (or binned) when displaying the full panorama, as mentioned above. However, if a particular area/item of interest is detected in the panoramic image, in certain embodiments, the image processing of FIG. 3 can be used to magnify the area/item of interest using a zoom feature at, for example, block 480₁. According to one embodiment, the zoom feature may display that portion of the image around the area and/or item of interest in a separate window at full pixel resolution (that is, every pixel may be displayed without binning). This zoom feature may be implemented on either the panoramic image or on a separate display device such as could be used for driving or navigation or both simultaneously. Also as illustrated in FIG. 4, an area and/or item of interest may be displayed at varying levels of magnification using the zoom feature illustrated by blocks 480₁₋ₙ. In addition, several areas and/or items of interest may be simultaneously displayed at the same or varying levels of magnification using the zoom feature illustrated by blocks 480₁₋ₙ. Any one or combination of image(s) of an area and/or item of interest that has been processed using the zoom feature, e.g., blocks 480₁₋ₙ, may be selectively displayed in the driver's display window.

In other embodiments, the FPGA(s) (e.g., FPGA(S) 160₁₋ₙ) may perform processing of image data in order to accomplish automatic target detection. In general terms, the detection algorithm seeks regions where certain image features have been detected, such as local contrast, motion, etc. To that end, target recognition may similarly be performed, whereby objects are automatically characterized based on recognized properties of the image. According to one embodiment, target recognition may be based on objects detected by a sensor (e.g., sensor pod 110). Alternatively, or in combination, targets may be identified through user input. Users can further provide geographic coordinates for enlarging or manipulation of a display window generated using one or more of zoom features 480₁₋ₙ.

It should further be appreciated that all of the various features, characteristics and embodiments disclosed herein may equally be applicable to panoramic imaging in the infrared band. However, since infrared cameras typically have a lower pixel count than do commercially available visible-spectrum cameras, the overall system resolution may be lower in such cases.

Finally, it should be appreciated that target tracking algorithms can be programmed into the FPGA(s) (e.g., FPGA(S) 160₁₋ₙ). Exemplary target tracking algorithms may include centroid, correlation, edge, etc. In that fashion, tracked items may be represented on a 360 degree panoramic display.

Referring now to FIG. 5, depicted is block diagram of an image processing sequence 500 which may be performed during the image correction of FIG. 4 (e.g., image correction blocks 415a-415d). Imaging data 505 received from an imaging device (e.g., imaging devices 310₁₋ₙ) may be corrected such that pixels are realigned at block 510. At block 515, a bayer interpolation process may be performed on image data to filter RGB colors of the imaging data. RGB color data may be converted to YUV color data to define the imaging data in terms of luma and chrominance components at block 520. Imaging data may then be equalized at block 525 automatically. At block 530, imaging data may be converted from YUV to RGB color data. According to another embodiment, process 500 may include barrel distortion correction at block 535 for correction of imaging data. Corrected imaging data 540 may be provided for translation and or blending. Process 500 has been described as performing specific steps for correcting image data, however it should by appreciated that additional and/or different acts may be performed by process 500.

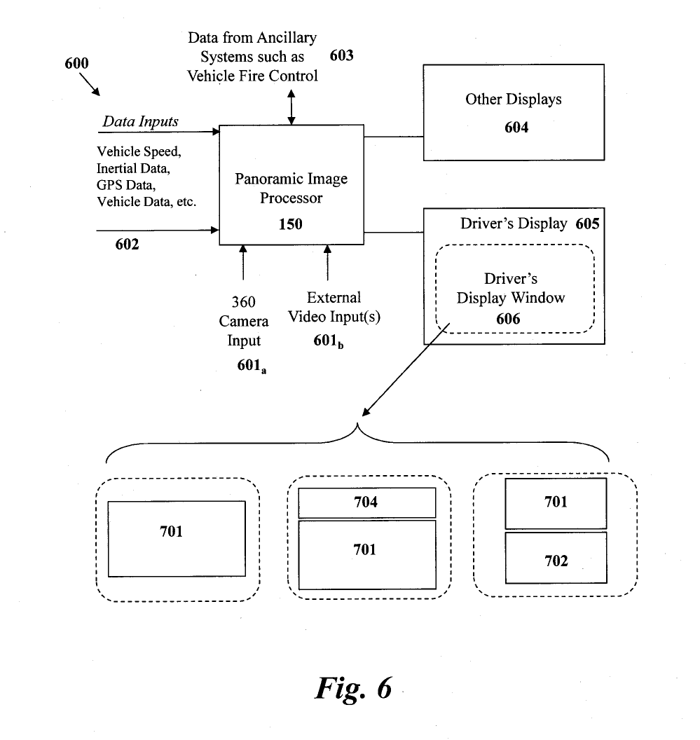

In another embodiment, the panoramic video imaging system may be incorporated into, or used in conjunction with, an intelligent driver's viewer system 600, as shown in FIG. 6, that can be implemented in a wide variety of applications, including various types of vehicles. Image processor 150 may receive video inputs 601_{a,b} from one or more high-resolution video cameras. The image processor 150 is capable of providing a wide panoramic view of the vehicle's environment from the one or more video camera inputs 601_{a,b}. The wide panoramic view may be output to and displayed on one or more displays 604, including a wide field panoramic display. When a sufficient number of video cameras are used, the image processor 150 is capable of providing a full 360 degree panoramic view of the vehicle's environment, which may also be output to and displayed on the one or more displays 604, at least one of which is a wide field panoramic display that can display a full 360 degree panoramic image. The panoramic video imaging system is also capable of continuously capturing full field of view imagery in real time and with low latency. Real-time, low latency imaging is necessary in order that the driver is able to perceive and effectively react to all manner of changing conditions of his vehicle and the environment. For purposes of piloting vehicles, real time requires video update rates of at least 24 frames per second and latency not exceeding 100 milliseconds.

Referring again to FIG. 6, image processor 150 may also receive vehicle data inputs 602 that may include, but are not limited to, vehicle speed, inertial data, GPS data, traffic reporting data, IFF information, and/or other vehicle-related operating parameters that can be implemented as digital or analog signals. Data from ancillary vehicle systems 603 or from external sources may also be received by image processor 150. These could comprise data from rangefinding devices, RF or laser radars such as such used for collision avoidance and others. Additionally, video from systems both onboard and remotely located, such as a weapon control system with dedicated, slewable long range imaging capability, can be received as an input to the image processor and selected for display. In other cases, video from certain cameras fixed to the vehicle or platform could similarly be selected for display. Other inputs that can be available to the image processor 150 include, but are not limited to, the following: inertial measurement data from accelerometers or an inertial measurement unit (IMU) that is either part of the panoramic video imaging system or located onboard the vehicle, vehicle speed, vehicle status metrics, and GPS coordinates including vehicle heading. Commands and data from other ancillary vehicle systems may also be received by image processor 150. For example, a military vehicle equipped with a weapon control system can provide data on its pointing coordinates, target of interest coordinates as well as status information. Also, shot detection systems can provide precise data on the location of gunfire using acoustic sensing. This information is then employed by the intelligent driver's viewer system 600 to manually or automatically control the positioning of the driver's display window 606, as well as to indicate to the driver other actions that should be taken based on the received commands or data. Conversely, a signal or command issued from the driver's station and using the driver's display window 606 could provide a cue to another vehicle sensor or subsystem which would use this data as an alert or to slew to the location so designated by the driver.

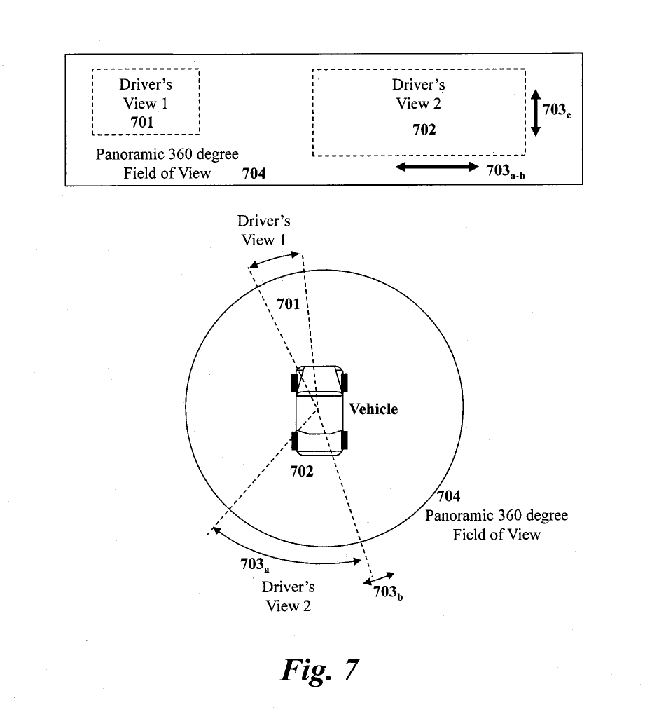

The wide panoramic field may be selected for sharing and communicated from the image processor 150 to a vehicle driver's display 605 as shown in FIG. 6. In one embodiment, the driver's display 605 can be separate from the one or more displays 604. As shown in FIG. 6, the driver's display 605 may include a driver's display window 606, which can provide selectable display options to the driver including any combination of a full panoramic image 704, and one or more segments or portions of the panoramic image, represented by field of views 701, 702, etc. (as shown in FIG. 7). For example, driver's display window 606 may display field of view 701 alone, field of view 701 in conjunction with a full panoramic image 704, full panoramic image 704 alone, field of view 701 simultaneously with field of view 702, or any other combination of views. It will be understood that the various fields of view that are displayed may be manually or automatically selected. The sizes and locations of these image segments are independent and variable and are selected from the larger panoramic field of view 704, which corresponds to the wide field panoramic display, for example, display 604 in FIG. 6. It is advantageous to provide a driver's display window 606 (either incorporated into or separate from panoramic field of view 704) in order to precisely control and optimize the location, resolution and magnification of the image presented to the vehicle driver. Moreover, such location and size is not static but may be moved and/or resized within two frame times (less than 1/15^{th} of a second) such as when switching views from a 12 o'clock position to a 6 o'clock position. This minimal switching time is allowed because the full panoramic video is continuously available within the image processor. In some situations it may be advantageous to display views that look simultaneously forward and to the rear (so as to simulate a rear-view mirror). The video cameras may be selected for spectral response or other performance characteristics in any combination of the following: infrared waveband, visible waveband, low-light level, near infrared or other devices capable of delivering a real-time image. The video to the operator/s may be switched between any of the sensor operating wavebands either manually or automatically such as when switching to IR or low light level TV if the ambient light level falls below some threshold.

In one embodiment, and as shown in FIG. 7, the field of view delivered to the driver's view(s) 701 and/or 702 can be adapted automatically to the speed of the vehicle and other external conditions. If the vehicle begins to reverse direction, for example, the driver's display window 606 may display a field of view that points immediately to the rear of the vehicle, such as driver's view 702. As another example, the driver's display window 606 may move automatically to the location designated by data input from an acoustic shot detection system. Furthermore depending on the vehicle's mission and other factors, such as type of roadway, the field of view(s) 701 and/or 702 that are displayed in the driver's display window 606 may be automatically reduced (or in some cases expanded) as the vehicle speed increases, or in response to other factors, to provide a longer range for the perception of objects or events in the vehicle's path. As explained below, the adjustment in size of any of the driver's views, such as, for example, the field of view 702 displayed in the driver's display window 606 is represented by arrows 703ₐ, 703_{b}, and 703_{c}. This longer range afforded by the reduced field of view displayed in the driver's display window 606 can improve the reaction time of the vehicle driver to external events. A variant of this approach could supply a lower resolution image 702 at the left and right edges of the driver's display window 606 so as to provide the vehicle driver with additional situational awareness cues at higher vehicle speeds. In a similar fashion, severe road conditions might dictate a wider field of view 702 to be displayed in the driver's display window 606 to allow the vehicle driver to better negotiate nearby terrain irregularities or to avoid obstacles. In another embodiment, also shown in FIG. 7, the driver's display window 606 can be displayed as part of the images displayed by the one or more displays 604. For example, the driver's display window 606 can be integral with a wide field panoramic display that can display a full 360 degree panoramic image, such as the 360 degree panoramic field of view 704. In this manner, a driver's view 701 and/or 702 may be displayed with the 360 degree panoramic field of view 704 on a wide field panoramic display. Also as shown in FIG. 7, driver's views 701 and 702 can be separately and simultaneously displayed with the 360 degree panoramic field of view 704. Additional driver's views could also be displayed in this manner. Any driver's view, such as driver's view 701 and 702, are movable within the 360 degree panoramic field of view 704.

In another embodiment, an ancillary system, such as a remotely operated weapon control system, might be resident on a vehicle such as an army vehicle. Such a system generally has a separate display that is dedicated for use by the system operator. It is often advantageous to share with the vehicle driver the visual and contact information being observed by the weapon system operator. Information such as pointing coordinates and status information that is transmitted from the weapon control system to the image processor 150 may be used to quickly command and adjust the position and the field of view 701 displayed by the driver's display window 606 when circumstances so demand, and vice versa. Any information captured and/or generated by the intelligent driver's viewer system 600, such as the pointing coordinates of the driver's display window 606, can be shared with an ancillary system, such as the weapon system operator or with the operator of the first panoramic display. As shown in FIG. 7, the mobility of views 701, 702, etc. in the driver's display window 606 within the panoramic field of view 704 is represented by vertical directional arrows 703_{c} and horizontal directional arrows 703_{a,b}. Depending on the vehicle and application, other inputs that might be used to control the driver's windows 701, 702, etc. could include FBCB2 (Force Battle Command Brigate and Below), AIS (Automatic Identification System), IFF (Identification Friend or Foe) or radar and ranging data from onboard or external devices.

In another embodiment, the direction of the center of the field of view of the driver's windows 701, 702, etc. can be adjusted or biased by the image processor 150 instantly and continuously toward the direction that the vehicle is turning to provide an optimum view to the driver. The changing vehicle direction is sensed by inertial sensors described above and the degree of bias is proportional to the turning rate and radius of the vehicle. Data from radar or range detectors that measures the distances or bearings to nearby vehicles or to obstacles and/or edge of road conditions can be used to automatically optimize the size and placement of the driver's display window 606. Details of any potential hazards or other relevant information can be displayed to the vehicle driver to improve his situational awareness.

GPS sensors and devices may provide geographical coordinates and mapping information as well as supplying routing directions. The driver's field of views 701, 702, etc. can be intelligently adapted and optimized using this GPS information. On a land vehicle, for example, the field of view displayed by the driver's display window 606 could be increased as the vehicle approaches an intersection to provide improved awareness of traffic conditions there. In addition, the field of view could be slewed toward the direction of an expected turn using the GPS data, which may be augmented with data from the inertial sensors.

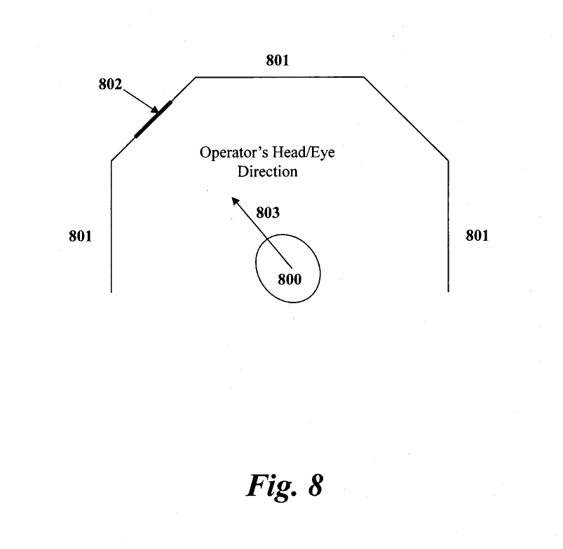

It is particularly important that remotely piloted vehicles for land, sea or air applications, which do not have an onboard driver, can communicate data for display on both a driver's window for piloting and a wide field panoramic display for situational awareness. In one such embodiment shown in FIG. 8, it is advantageous to use, in addition to the inputs described above, inputs from the physical state of the vehicle driver 800 (or another operator) that provide cues to appropriately size and locate the driver's display window 802 within the panoramic field of view 801. Body motion, hand gestures and/or head position 803 are readily obtained from appropriately positioned accelerometer sensors while trackers that estimate the direction of the human eye are also available. Using these inputs, the driver's display window 802, which may be of higher resolution, can be made to track cues supplied by the driver 800 or another chosen operator as shown in FIG. 8. FIG. 8 shows an operator 800 surrounded by several displays that together present a full 360 degree or partial panoramic field of view 801. Thus, the optimally sized driver's display window 802 is particularly advantageous not only for driving and piloting the vehicle, but also for purposes of surveillance. In this manner, the panoramic field of view 801 provides full situational awareness while a higher resolution, optimized driver's display window 802 may be located and sized adaptively based on any combination of the chosen inputs.

In addition to the data used to optimize the driver's display window 802, any other vehicle data that can be made available in digital or analog form and considered important can be displayed to the driver and/or other system operators. Therefore metadata such as vehicle speed, vehicle status metrics like fuel level, temperature, voltages, etc. and GPS information, data from range and/or collision avoidance measurements, AIS, IFF, FBCB2, etc. can be displayed on the panoramic field of view 801 and/or the driver's display window 802. Additionally, various graphic overlays that are derived from scene based image processing may be selected to be superimposed on one or more of the display devices described. For example, line detection algorithms can define for display the location of road edges and intersections and other algorithms can detect and highlight objects or obstructions in the field. Such capabilities might be beneficial under certain visibility conditions or to accentuate features in the environment. Graphics, such as, for example, icons, that represent regions of particular interest, possible threats, or other information may also be overlaid onto the displayed images.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art. Trademarks and copyrights referred to herein are the property of their respective owners.

What is claimed is:

1. A low-latency, high-resolution, continuous motion full 360 degree panoramic video imaging and display system adaptable for use with a vehicle, comprising:
a plurality of high-resolution video cameras mountable to the vehicle, each video camera generating an at least 500 kilopixel video camera image signal as a digital stream of individual pixels representative of images in the field of view of the respective video camera;
a communication link between the plurality of video cameras and an image processor for communicating the digital pixel stream video camera image signals from the plurality of video cameras to the image processor;
the image processor receiving the digital pixel stream video camera image signals from each of the plurality of video cameras and processing the digital pixel stream video camera image signals from each of the plurality of video cameras in parallel with the digital pixel stream video camera image signals from others of the plurality of video cameras to generate combined video signals representative of a full 360 degree field of view around the plurality of video cameras;
a communication link between the image processor and a plurality of display devices;
the plurality of display devices configured to display the combined video signals received from the image processor as full, distortion-corrected and seamless combined 360 degree panoramic images in the field of view around the plurality of video cameras, with each combined 360 degree panoramic image being displayed from the digital pixel stream video camera image signals within not more than 100 milliseconds from the imaging event and with each of the video camera images that together comprise the combined 360 degree panoramic image reflecting the same instant in time; and
at least one of the plurality of display devices being a driver's display window.

2. A video imaging and display system as set forth in claim 1, wherein at least one of the plurality of video cameras is configured to collect at least one of visual imaging data, non-visual imaging data, infrared data, near-infrared data, thermal imaging data, microwave imaging data and magnetic imaging data.

3. A video imaging and display system as set forth in claim 2, wherein the images displayed on the plurality of display devices are selectable to correspond to the type of data collected by the plurality of video cameras.

4. A video imaging and display system as set forth in claim 1, wherein the driver's display window is configured to selectably display a portion of the combined 360 degree panoramic images.

5. A video imaging and display system as set forth in claim 4, wherein the portion of the combined 360 degree panoramic images displayed on the driver's display window is switched to another portion of the combined 360 degree panoramic images in less than one-fifteenth of a second.

6. A video imaging and display system as set forth in claim 4, wherein the portion of the combined 360 degree panoramic images displayed on the driver's display window is manually selected by a driver of the vehicle.

7. A video imaging and display system as set forth in claim 4, wherein the portion of the combined 360 degree panoramic images displayed on the driver's display window is automatically selected based on vehicle data signals received by the image processor.

8. A video imaging and display system as set forth in claim 7, wherein the vehicle data signals received by the image processor include at least one of vehicle speed, vehicle direction, inertial data, GPS data, traffic reporting data, IFF data, FBCB2 data, AIS data, radar data, ranging data, acoustic data, and weapon system data.

9. A video imaging and display system as set forth in claim 1, wherein the driver's display window is configured to selectably and simultaneously display a plurality of portions of the combined 360 degree panoramic images.

10. A video imaging and display system as set forth in claim 9, wherein at least one of the plurality of portions of the combined 360 degree panoramic images being displayed by the driver's display window represents a 360 degree panoramic view.

11. A video imaging and display system as set forth in claim 1, wherein the driver's display window displays information corresponding to vehicle data signals received by the image processor.

12. A video imaging and display system as set forth in claim 11, wherein the information corresponding to vehicle data signals includes at least one of vehicle speed, vehicle status metrics, GPS information, range measurements, collision avoidance measurements, AIS, IFF, and FBCB2.

13. A video imaging and display system as set forth in claim 1, wherein at least one of the plurality of display devices is configured to display graphics over the images being displayed.

14. A video imaging and display system as set forth in claim 13, wherein the graphics include the result of scene-based processing.

15. A video imaging and display system as set forth in claim 13, wherein the graphics include icons.

16. A video imaging and display system as set forth in claim 1, wherein image signals received from a system external to the video imaging and display system are received by the image processor and displayed on at least one of the plurality of display devices.

17. A video imaging and display system as set forth in claim 1, wherein data associated with the images displayed on at least one of the plurality of display devices are communicated to a system external to the video imaging and display system.

18. A video imaging and display system as set forth in claim 17, wherein the communicated data is used to command and direct the system external to the video imaging and display system.

19. A low-latency, high-resolution, continuous motion full 360 degree panoramic video imaging and display system adaptable for use with a vehicle, comprising:
a plurality of high-resolution video cameras mountable to the vehicle, each video camera generating an at least 500 kilopixel video camera image signal as a digital stream of individual pixels representative of images in the field of view of the respective video camera;
a communication link between the plurality of video cameras and an image processor for communicating the digital pixel stream video camera image signals from the plurality of video cameras to the image processor;
the image processor receiving the digital pixel stream video camera image signals from each of the plurality of video cameras and processing the digital pixel stream video camera image signals from each of the plurality of video cameras in parallel with the digital pixel stream video camera image signals from others of the plurality of video cameras to generate combined video signals representative of a full 360 degree field of view around the plurality of video cameras;
a communication link between the image processor and a plurality of display devices;
the plurality of display devices configured to display the combined video signals received from the image processor as full, distortion-corrected and seamless combined 360 degree panoramic images in the field of view around the plurality of video cameras, with each combined 360 degree panoramic image being displayed from the digital pixel stream video camera image signals within not more than 100 milliseconds from the imaging event and with each of the video camera images that together comprise the combined 360 degree panoramic image reflecting the same instant in time; and
at least one driver's display window in communication with the image processor and configured to selectably display a portion of the combined 360 degree panoramic images.
